(19) United States
(12) Patent Application Publication
(10) Pub. No.: US 2015/0379566 A1
(43) Pub. Date: Dec. 31, 2015

(54) THROTTLING CONTENT

(71) Applicant: Google Inc., Mountain View, CA (US)

(72) Inventor: Patrick Hummel, Cupertino, CA (US)

(21) Appl. No.: 14/314,390

(22) Filed: Jun. 25, 2014

(51) Int. Cl. G06Q 30/02

(52) U.S. Cl. CPC G06Q 30/0254; G06Q 30/0275

(57) ABSTRACT

An example process includes determining a first quality metric that is indicative of a quality of an opportunity for distribution of content from a content provider as compared to other content providers, where the first quality metric is based on a first predicted access rate and a second predicted access rate, where the first predicted access rate is based on features that are dependent on the content provider, and where the second predicted access rate is based on features that are independent of the content provider. The example process also includes determining a second quality metric that is based on the first predicted access rate of the content; determining, a weight to apply to the first quality metric and to the second quality metric; and determining a weighted average of the first quality metric and the second quality metric that is based on the weight.

### TECHNICAL FIELD

This disclosure relates generally to throttling content in an online content auction.

### BACKGROUND

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers) for the presentation of content.

Content providers, such as advertisers, may distribute content through an auction based on various types of information. In the auction, content providers submit bids specifying amounts that the content providers are willing to pay for presentation of their content. Examples of such information that may be bid on include, but are not limited to, keywords, geography, and demographics.

Content providers, however, have limited resources (e.g., money) that can be used in the distribution of content. Content providers therefore attempt to allocate those resources to content distribution that provides an overall benefit, such as an increased number of conversions.

### SUMMARY

Example techniques for throttling content may include the following: determining a first quality metric that is indicative of a quality of an opportunity for distribution of content from a content provider as compared to other content providers, where the first quality metric being is on a first predicted access rate of the content and a second predicted access rate of the content, where the first predicted access rate of the content is based on features that are dependent on the content provider, and where the second predicted access rate of the content is based on features that are independent of the content provider. The example techniques may also include: determining a second quality metric that is based on the first predicted access rate of the content; determining a weight to apply to the first quality metric and to the second quality metric, where the weight is based on an expected return resulting from distribution of the content; determining a weighted average of the first quality metric and the second quality metric that is based on the weight; and distributing the content via a content auction based, at least in part, on the weighted average. The example techniques may also include one or more of the following features, either alone or in combination.

Determining the first quality metric may include: determining a first predicted click-through rate (PCTR) for the content, where the first PCTR corresponds to the first predicted access rate; determining a first value based on the first PCTR; determining a second PCTR, where the second PCTR corresponds to the second predicted access rate; determining a second value based on the second PCTR; and determining the first quality metric based on a difference between the first value and the second value.

Determining the first value may include determining a logarithm based on the first PCTR. Determining the second value may include determining a logarithm based on the second PCTR.

Determining the weight may include: selecting a weight; determining a weighted average of the first quality metric with the selected weight applied and the second quality metric with the selected weight applied; comparing the weighted average to an average of weighted averages for the content for all opportunities in which the content participated; storing the weighted average in a first bin or a second bin based on the comparing, where the first bin corresponds to weighted averages that exceed the average of the weighed averages and the second bin corresponding to weighted averages that are below the average of the weighted averages; determining a value based on a percentage difference in conversions per unit spent by the content provider between the first bin and the second bin; and selecting the weight based on the value. The weight is selected that produces the largest percentage difference, the largest percentage difference corresponding to a largest return on investment for distribution of the content.

Distributing may include: storing a value corresponding to the weighted average in a first bin or in a second bin, where the first bin corresponds to weighted averages that exceed an average of weighted averages and the second bin corresponds to weighted averages that are below the average of weighted averages; determining a ratio corresponding to an amount that a content provider would spend in the first bin relative to the second bin; and determining a probability that the content should be throttled. The content may be distributed based on the ratio and the probability. The ratio is defined as “r” and the probability is defined as “p”. If p·(r+1)>r, then distributing includes the content competing in a content auction for queries in the first bin with probability “1” and competing in the content auction for queries in the second bin with probability p·(r+1)−r. If p·(r+1)≦r, then distributing includes the content competing in a content auction for queries in the first bin with probability p·(r+1)/r and competing in the content auction for queries in the second bin with probability “0”.

The content may include online advertising, and the opportunity for distribution of content may be a content auction.

Determining the first value may include determining a logarithm of odds of the first PCTR. Determining the second value may include determining a logarithm of odds of the second PCTR.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a block diagram of an example network environment on which the example processes described herein can be implemented.

FIG. 2 is an example of a process for performing throttling.

FIG. 3 is a block diagram of a computer system on which the example process of FIG. 2 may be performed.

Like reference symbols in the various drawings indicate like elements.

### DETAILED DESCRIPTION

The example systems and processes herein are described in the context of online advertising (referred to as an “ad” or “ads”); however, the systems and processes described herein are applicable to throttling any appropriate type of online content in any appropriate type of distribution process.

Content, such as advertising, may be provided to network users based, e.g., on demographics, keywords, language, and interests. For example, an ad may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on a search results page in this example. The user may select the ad by clicking-on the ad. In response, a hyperlink associated with the ad directs the user to another Web page. For example, if the ad is for ABC Travel Company, the Web page to which the user is directed may be the home page for ABC Travel Company. This type of content access is known as click-through. In this context, a “click” is not limited to a mouse click, but rather may include a touch, a programmatic selection, or any other interaction by which the ad may be selected.

Generally, a click-through rate (CTR) corresponds to a ratio of number of clicks on content (e.g., an ad) to number of impressions of the content for a query or on a page. In an online advertising context, the CTR can be viewed as a measure of success of the ad, with a higher CTR corresponding to a more successful ad and a lower CTR corresponding to a less successful ad. The predicted click-through rate (PCTR) is a prediction of the CTR for a content item under various circumstances, e.g., when presented along with other content on a page, where presented on the page, the geography to which the content item is presented, and so forth.

A content auction may be run to determine which content is to be output in response to a query, which may include one or more keywords or other search parameters. In the auction, content providers may bid on specific keywords (which are associated with their content). For example, a sporting goods ads provider may associate words such as “baseball”, “football” and “basketball” with their ads. The content provider may bid on those keywords in the content auction, typically on a cost-per-click (CPC) basis. The content provider's bid is an amount (e.g., a maximum amount) that the provider will pay in response to users clicking on their displayed content. So, for example, if a content provider bids five cents per click, then the content provider may pay five cents each time their content is clicked-on by a user, depending upon the type of the auction. In other examples, payment need not be on a CPC basis, but rather may be on the basis of other actions (e.g., an amount of time spent on a landing page, a purchase, and so forth).

Bidding in a content auction typically takes place against other content providers bidding for, e.g., the same keywords. So, for example, if a user enters a query into a search engine (to perform a search for related content), a content management system may select content items from different content providers that are associated with keywords in the query or variants thereof. The content auction is then run (e.g., by the content management system) to determine which content (e.g., which ads) to serve along with the search results or any other requested content. The winner may be decided, e.g., based on bidding price, relevance of the keywords to content, and other factors. In this context, a page includes any display area, such as a Web page, a continuously scrollable screen, and so forth. In some implementations, winners of the content auction will be accorded the most preferred slot(s) on the page, while others will be accorded slots that are less preferred.

In some cases, rather than bidding on keywords, content providers may bid on other information. For example, a content provider may bid to distribute content to a particular geographic area, to a particular demographic, to particular types of content (e.g., Web pages), combinations of these, and so forth.

Content provider budgets are often limited. For example, content providers (e.g., advertisers) may request that a content management system spend no more than a specified budget over the course of a specified period of time. At the same time, content providers may make bids in a content auction that are large enough so that, if their content were presented every time they had a bid that was large enough to win one of the slots available for auction, then the content providers would ultimately spend more than their budget for the specified period of time. However, it is possible to “throttle” such “budget-constrained” content providers and their content by allowing content from such content providers to compete only in auctions with a given (e.g., predefined minimum) probability of success. In some implementations, the probability is selected so that a content provider will not exceed their specified budget, and will spend an amount equal to their specified budget over the specified period of time. Throttling thus includes limiting the number and/or types of auctions in which content, such as an ad, may participate.

When performing throttling during an auction, it may be desirable to attempt to show content from a budget-constrained content provider in circumstances that will give the content provider a relatively high (e.g., highest) return on investment (ROI) or a relatively large (e.g., largest) amount of conversions per dollar spent. This may be done by comparing the PCTR for a given impression of content to an average PCTR for that same content over all auctions in which the content may participate, and by generating a standard quality metric based on the comparison. Throttling may be performed based on this standard quality metric. For example, in an online advertising context, an auction resulting from a query where an ad has a higher PCTR tends to be higher-quality advertising opportunity (or, more generally, “content distribution opportunity”) for an advertiser than an auction where the ad has a lower PCTR. If an ad has a relatively low PCTR in an auction, then that advertising opportunity is deemed low-quality. In the case of low-quality advertising opportunities, the content management system is more likely to throttle an ad out of auction because such an auction provides the advertiser with relatively lower ROI than auctions with higher PCTRs. In this regard, an input query typically gives rise to a content auction. So, either the query or the resulting auction may be characterized as the “advertising opportunity”.

While a quality-based throttling system of the type described above can improve ROI, there may be room for improvement. For example, even in an auction in which an ad has a relatively low PCTR, it is possible that the advertising opportunity would afford the advertiser a relatively high ROI if the advertising opportunity still happens to be an unusually good match for the advertiser as compared relative to other advertisers (e.g., the advertising opportunity could have a relatively high conversion rate and could also be relatively cheap due to little competition in the auction). In another example, in cases where one ad's PCTR is relatively high, it may be the case that other advertisers also have relatively high PCTRs. This is because CTRs are driven, in part, by characteristics of the publisher or the user that make all ads in the auction more or less likely to receive a click. In cases where other advertisers also have high PCTRs, the advertising opportunity may be less likely to lead to high ROI (even though the PCTR is high), since the competition in the auction means that even if the advertiser wins the auction, the impression won is likely to be expensive. Furthermore, there may be less benefit to having this advertiser in the auction because there are already plenty of ads that can be shown, for which there is a high-quality advertising opportunity.

Accordingly, in some cases, enhancing an advertiser's ROI may include more than simply considering the absolute quality of the advertising opportunity as measured through comparisons of PCTRs to overall averages. For example, in some cases, it may be beneficial to consider the extent that an advertising opportunity (e.g., an auction for an ad slot) is likely to be a higher-quality advertising opportunity for a particular advertiser than it is for other advertisers.

Accordingly, described herein are example processes that quantify the extent to which a particular advertising opportunity is likely to be a higher-quality advertising opportunity for a particular advertiser than it is for the other advertisers. In some implementations, the example processes do not rely on foreknowledge of the PCTRs or bids of the other advertisers. This is because, in some cases, throttling decisions are made before PCTRs or the bids of other advertisers are known. In the example processes, an overall score that can be used in making throttling decisions is determined. In some implementations, the overall score weights information about both the absolute quality of the advertising opportunity and information about the extent to which a particular advertising opportunity is likely to be a higher-quality advertising opportunity for a particular advertiser than it is for other advertisers. This overall score is used in deciding whether to throttle an ad in an auction in an attempt to enhance ROI for the advertiser sponsoring that ad.

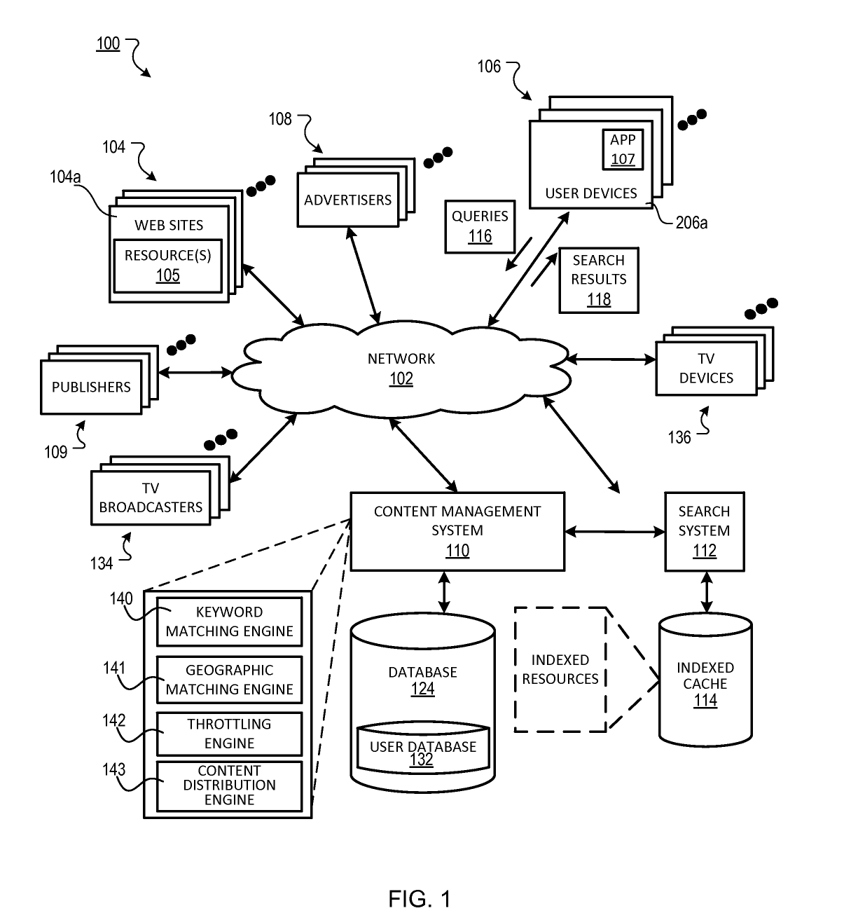

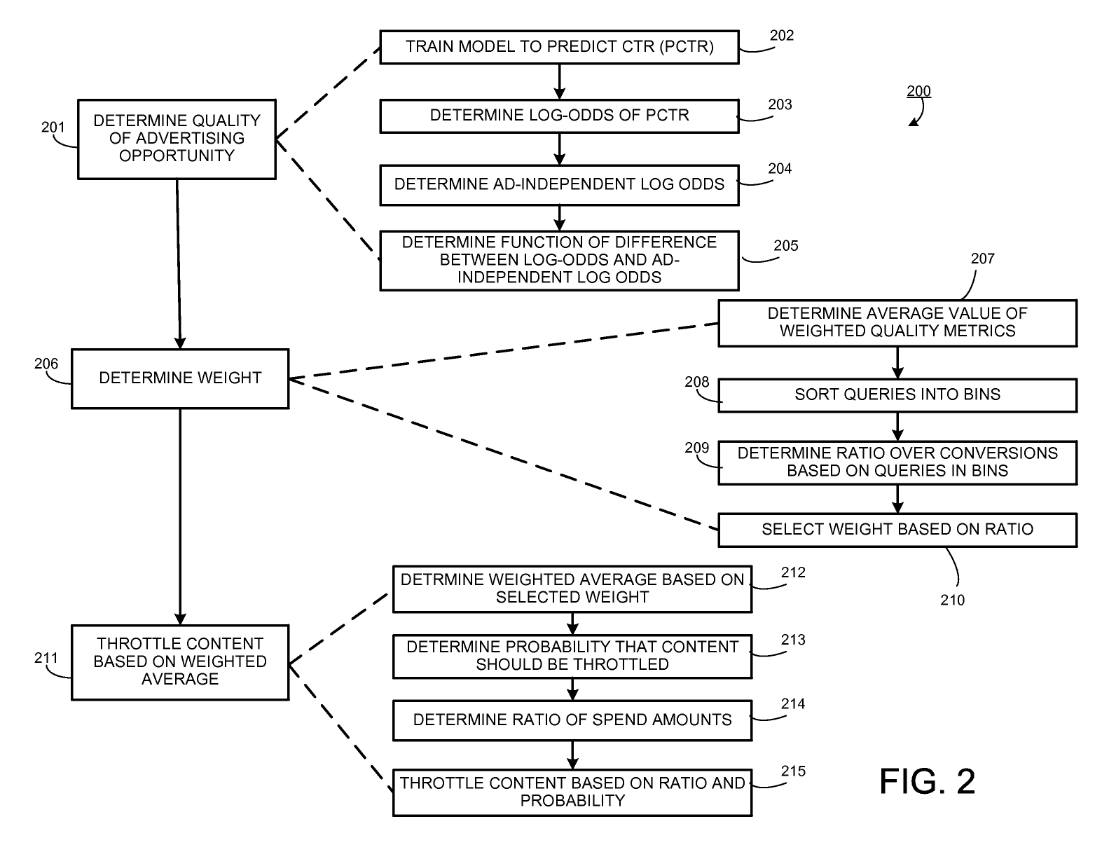

An example process for performing throttling is described with respect FIG. 2 below. FIG. 1 shows a network environment and content management system on which the example throttling process may be implemented. In this regard, FIG. 1 is a block diagram of an example environment 100 in which content, such as ads, may be served using an online content auction. The example environment 100 includes a network 102.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 102 connects various entities, such as Web sites 104, user devices 106, content providers (e.g., advertisers 108), online publishers 109, and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

In FIG. 1, Web sites 104 can include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 can be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can include content, such as words, phrases, images and sounds, that can include embedded information (such as meta-information hyperlinks) and/or embedded instructions (such as JavaScript scripts).

To facilitate searching of resources 105, environment 100 can include a search system 112 that identifies the resources 105 by crawling and indexing the resources 105 provided by the content publishers on the Web sites 104. Data about the resources 105 can be indexed based on the resource 105 to which the data corresponds. The indexed and, optionally, cached copies of the resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a typically stores one or more user applications, such as a Web browser, to facilitate the sending and receiving of data over the network 102. A user device 106a that is mobile (or simply, “mobile device”), such as a smartphone or a table computer, can include an application (“app”) 107 that allows the user to conduct a network (e.g., Web) search. User devices 106 can also be equipped with software to communicate with a GPS system, thereby enabling the GPS system to locate the mobile device.

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116. The search system 112 identifies the resources 105 in the form of search results 118 and returns the search results 118 to a user device 106 in search results pages. A search result 118 can include data generated by the search system 112 that identifies a resource 105 that is responsive to a particular search query 116, and includes a link to the resource 105. An example search result 118 can include a Web page title, a snippet of text or a portion of an image obtained from the Web page, and the URL (Unified Resource Location) of the Web page.

Content management system 110 can be used for selecting and providing content in response to requests for content. Content management system 110 also can, with appropriate user permission, update database 124 based on activity of a user. The user may enable and/or disable the storing of such information. In this regard, with appropriate user permission, the database 124 can store a profile for the user which includes, for example, information about past user activities, such as visits to a place or event, past requests for resources 105, past search queries 116, other requests for content, Web sites visited, or interactions with content. User interests may also be stored in the profile and, in some examples, may be determined from the information about past user activities. In some implementations, the information in database 124 can be derived, for example, from one or more of a query log, an advertisement log, or requests for content. The database 124 can include, for each entry, a cookie identifying the user, a timestamp, an IP (Internet Protocol) address associated with a requesting user device 106, a type of usage, and details associated with the usage.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 110 may include a geographic (or “geo-”) matching engine 141 to compare geographic information (e.g., numerical values for place names) obtained from words in input queries to geographic information associated with content. Content management system 110 may also include other engines (not shown) for matching input demographics to desired demographics of an advertising campaign, for identifying Web pages or other distribution mechanisms based on content, and so forth.

When a resource 105 or search results 118 are requested by a user device 106, content management system 110 can receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource or a search query 116 for which search results are requested can also be provided to the content management system 110 to facilitate identification of content that is relevant to the resource or search query 116.

Based at least in part on data generated from and/or included in the request, content management system 110 can select content that is eligible to be provided in response to the request (“eligible content items”). For example, eligible content items can include eligible ads having characteristics matching keywords, geographic information, demographic information, known interests, etc. associated with corresponding content. In some implementations, the universe of eligible content items (e.g., ads) can be narrowed by taking into account other factors, such as previous search queries 116. For example, content items corresponding to historical search activities of the user including, e.g., search keywords used, particular content interacted with, sites visited by the user, etc. can also be used in the selection of eligible content items by the content management system 110.

Content management system 110 can select the eligible content items (e.g., ads) that are to be provided for presentation in slots of a resource 105 or search results page 118 based, at least in part, on results of an auction, such as a second price auction. For example, for eligible content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid for keywords can specify an amount that a content provider is willing to pay for each 1000 impressions (e.g., presentations) of the content item, referred to as a CPM bid. Alternatively, the bid for keywords can specify an amount that the content provider is willing to pay for a selection (e.g., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

In some implementations, a content provider can bid for an audience of users. For example, one or more of the publishers 109 and/or the content management system 110 can identify one or more audiences of users, where each user in the audience matches one or more criteria, such as matching one or more demographics, known interests, or other user-specific criteria.

An audience of users can be represented, for example, as a user list. User lists or other representations of audiences can be stored, for example, in a user database 132. A bid from a content provider can specify, for example, an amount that the content provider is willing to pay for each 1000 impressions (e.g., presentations) of the content item to a particular audience of users. The content management system 110 can, for example, manage the presentation of the content item to users included in a particular audience and can manage charging of the content provider for the impressions and distributing revenue to the publishers 109 based on the impressions.

In some implementations, TV (Television) broadcasters 134 produce and present television content on TV user devices 136, where the television content can be organized into one or more channels. The TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 110 may include a throttling engine 142. Throttling engine 142 may implement all or part of the example processes described herein for throttling content providers/content in a content auction. Content selected for output may be distributed by content distribution engine 143, which is also part of the content management system.

FIG. 2 is a flowchart showing an example process 200 that may be performed by content management system 110 including, at least partly, by throttling engine 142. Process 200 is described in the context of online advertising (“ads”); however, process 200 is applicable for use in presentation of any appropriate online content or other distributable content.

According to process 200, it is determined (201) whether a particular advertising opportunity (e.g., a content auction resulting from an input query) is a high-quality advertising opportunity for an advertiser as compared to other advertisers. In this example, “high-quality” may mean that the advertising opportunity exceeds a specified threshold. For example, the advertising opportunity may have a projected ROI over a certain level, may be predicted to achieve a certain number of conversions, and/or may be measured by any other appropriate metric.

Example process 200 for estimating whether a particular advertising opportunity is a high-quality advertising opportunity may include the following operations. A machine-learning process trains (202) a model to predict a CTR of an ad for an auction. In some implementations, the model is trained using the “odds” that an ad will be accessed (e.g., clicked-on/selected) in a particular circumstance. In this example, the odds are defined as the ratio of the probability that an ad will receive a click to the probability that the ad will not receive a click. The example model uses the logarithm of the odds (also referred to as “log-odds” or “logit”), and is defined such that the log-odds of the PCTR of an ad is a linear function of various features. Stated mathematically, if logit(q) represents the log-odds of the PCTR of a given ad, then logit(q) may be written as logit(q)=Σₖβₖxₖ, where xₖ represents the value of the k^{t h} feature in the model, and βₖ represents the coefficient on this feature. The example process determines (203) the log-odds of the PCTR for the ad in question, which is represent by logit(q), as noted above.

The example process also determines (204), for the advertising opportunity, a value called the “ad-independent log-odds” for the opportunity (auction/query). To determine this value, example process 200 determines what the PCTR would be for the subject ad if the only features considered in determining the PCTR are those features that influence the PCTR of the ad and that are independent of the identity of the advertiser (e.g., features common to all ads, such as features of the publisher or the user that influence the PCTR of the advertiser independent of the identity of the advertiser). In other words, the example process determines what the PCTR of the ad would be if coefficients of Σₖβₖxₖ on all features that are potentially different for different advertisers are set to zero. The ad-independent log-odds is represented mathematically by logit(̂q). In a typical PCTR determination, features that are considered in determining the PCTR include features that are dependent on the identity of the advertiser.

The example process determines a function of the difference (205) between logit(q)−logit(̂q), which is defined above. This function of the difference is a quality metric (e.g., a score) that corresponds to a measure of the extent to which an advertising opportunity is a high-quality opportunity (auction/query) for a given ad/advertiser as compared to other advertisers. In some implementations, the greater that the difference is, the more likely that the advertising opportunity is a high-quality advertising opportunity for the ad/advertiser, and the less that the difference is, the less likely that the advertising opportunity is a high-quality advertising opportunity for the ad/advertiser.

Example process 200 for determining whether and when to throttle an ad also includes determining the amount of weight to place on the quality metric determined in operation 205 above, and how much weight to place on the standard quality metric, defined above (in this example, determined by comparing the PCTR for a given impression of the ad to an average PCTR for the ad over all auctions in which the ad may participate). In this example, process 200 determines (206) a weight to apply to the quality metrics to produce an enhanced ROI.

To this end, example process 200 includes the following operations. In process 200, q₁ is determined. In this example, q₁ is a standard quality metric indicative of the quality of the advertising opportunity for an ad, which was described above (e.g., q₁ represents the PCTR of the ad). In this case, q₂ is a quality metric that represents a measure of the extent to which an advertising opportunity is a high-quality advertising opportunity for a given advertiser compared to other advertisers to which that opportunity is afforded (this value corresponds to a function of the difference of logit(q)−logit(̂q), defined above). In this example, for each advertiser, i, and each of possible weights, w, applied to the first quality metric, the average value of q₁^{w}q₂^{1-w} is determined (207) across all prior advertising opportunities (e.g., queries/auctions) in which the advertiser won the auction. In this example, the weights are integral multiples of 0.01, although other multiples and other weights may be used, and an iteration is performed for each weight, w. By way of example, a weight of “0.02” may be applied as q₁^{w} and a weight of “0.98” (1−0.02) may be applied as q₂^{1-w}, then a weight of “0.03” may be applied as q₁^{w} and a weight of “0.97” (1−0.03) may be applied as q₂^{1-w}, then a weight of “0.04” may be applied as q₁^{w} and a weight of “0.96” (1−0.04) may be applied as q₂^{1-w}, and so forth for all possible weights. According to process 200, the queries for which the advertiser, i, won an auction are sorted (208) into two bins. In this example implementation, the first bin contains only queries in which the realized value q₁^{w}q₂^{1-w} exceeded the average value of this weighted average for the subject ad over all auctions (conducted in response to an input query) in which the ad participated, and the second bin contains only queries in which the realized value of q₁^{w}q₂^{1-w} was less than the average value of this weighted average for the subject ad over all auctions.

For each advertiser, i, and for each possible weight, w, process 200 determines (209) the ratio of advertiser i′s conversions per some cost (e.g., dollar spent) for queries in the first bin to advertiser i's conversions per the cost (e.g., dollar spent) for queries in the second bin. For each possible weight, w, on the first quality metric, process 200 determines a weighted average of the percentage difference in the advertisers' conversions per cost (e.g., dollar spent) between the first bin and the second bin. In this example, a weight is selected (210) that results in the largest such percentage difference. In this regard, in this example, the largest percentage difference corresponds to the highest ROI.

Process 200 uses the weighted average of the two quality metrics in deciding whether and when to distribute (e.g., to throttle) (211) content (e.g., an ad) via an auction as follows. Example process 200 determines (212) the weighted average (q₁^{w}q₂^{1-w}) using the selected weight, w, over all auctions for which an ad has competed. Process 200 identifies whether that weighted average falls in (i) a first bin containing queries in which the weighted average value q₁^{w}q₂^{1-w} exceeded the average value (which, in this example, is the average value of the weighted averages for all queries in which the advertiser won the auction), or (ii) a second bin containing queries in which the weighted average value of q₁^{w}q₂^{1-w} was less than the average value. Process 200 bins the weighted average value, q₁^{w}q₂^{1-w}, accordingly.

Example process 200 determines (213) the probability with which an ad should be throttled so that that an advertiser will spend an amount equal to their specified budget over a specified period of time. In this example, p represents the probability with which an ad should compete in an auction to satisfy this constraint. In an example, the advertiser's budget is determined and compared against how much the advertiser would have spent if the ad participated in every auction. For example, if the advertiser's budget is $30, and the advertiser would have spent $100 if the ad had competed in every auction, then the probability, p, here is 30%. A lower value of “p” indicates that an advertiser is more budget-constrained and a higher value of “p” indicates that an advertiser is less budget-constrained.

Example process 200 determines how much the advertiser would spend in the first bin of queries and how much the advertiser would spend in the second bin of queries if the advertiser were throttled at random with the probability previously specified. In this regard, SH represents the amount the advertiser would spend in the first bin of queries (where the weighted average of the quality metric exceeds the average value of the weighted average, q₁^{w}q₂^{1-w}) and SL represents the amount the advertiser would spend in the second bin of queries (where the weighted average of the quality metric is below the average value of the weighted average, q₁^{w}q₂^{1-w}). Example process 200 determines (214) the ratio between these two spend amounts, r=SH/SL.

If the probability p times r+1 is such that p·(r+1)>r, process 200 throttles (215) the advertiser in such a way that the advertiser competes in a content auction for queries in the first bin with probability “1” and competes in the content auction for queries in the second bin with probability p·(r+1)−r. Otherwise (if p·(r+1)≦r), process 200 throttles (215) the advertiser in such a way that the advertiser competes in a content auction for queries in the first bin with a probability p·(r+1)/r and competes for queries in the second bin with a probability “0”.

As described above, example process 200 uses ad-independent odds that can be calculated from a machine learning system that is then used to approximate the extent to which a particular query is a higher-quality query for a given advertiser than that query is for other advertisers. Example process 200 also includes operations for determining the amount of weight to place on different quality metrics of a query for an advertiser in deciding whether or not to throttle an ad. This is process can be used not only for incorporating the particular new quality metric described herein, but also for incorporating any additional quality metrics into a quality-based throttling system to supplement, rather than replace, existing quality-based throttling metrics.

Advantages of example process 200 may include enabling one to decide which queries a budget-constrained advertiser should take part in by considering not only the absolute level of quality of the particular query, but also the extent to which a query is likely to be a relatively high-quality advertising opportunity for this particular advertiser compared to other advertisers. Example process 200 also enables one to change how one implements quality-based throttling over time by automatically adapting the amount of weight that one places on various quality metrics in response to changing circumstances.

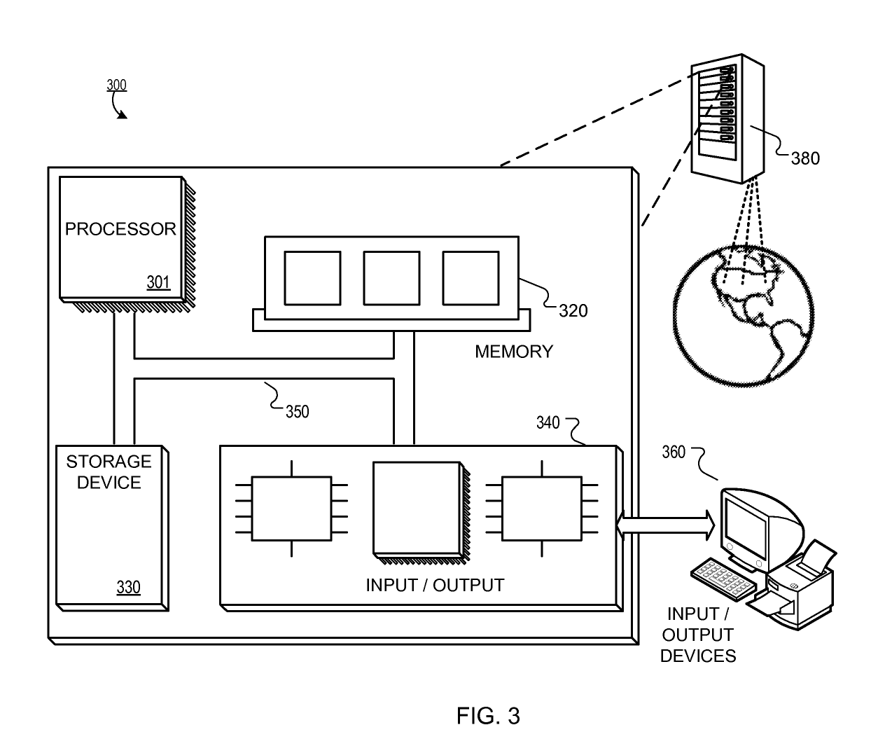

FIG. 3 is block diagram of an example computer system 300 that may be used in performing the processes described herein. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, or some other large capacity storage device.

The input/output device 340 provides input/output operations for the system 300. In one implementation, the input/output device 340 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 360.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 300 is depicted as a rack in a server 380 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method performed by one or more processing devices, comprising:
determining, by the one or more processing devices, a first quality metric that is indicative of a quality of an opportunity for distribution of content from a content provider as compared to other content providers, the first quality metric being based on a first predicted access rate of the content and a second predicted access rate of the content, the first predicted access rate of the content being based on features that are dependent on the content provider, the second predicted access rate of the content being based on features that are independent of the content provider;
determining, by the one or more processing devices, a second quality metric that is based on the first predicted access rate of the content;
determining, by the one or more processing devices, a weight to apply to the first quality metric and to the second quality metric, the weight being based on an expected return resulting from distribution of the content;
determining, by the one or more processing devices, a weighted average of the first quality metric and the second quality metric that is based on the weight; and
distributing, by the one or more processing devices, the content via a content auction based, at least in part, on the weighted average.

2. The method of claim 1, wherein determining the first quality metric comprises:
determining a first predicted click-through rate (PCTR) for the content, the first PCTR corresponding to the first predicted access rate;
determining a first value based on the first PCTR;
determining a second PCTR, the second PCTR corresponding to the second predicted access rate;
determining a second value based on the second PCTR; and
determining the first quality metric based on a difference between the first value and the second value.

3. The method of claim 1, wherein determining the first value comprises determining a logarithm based on the first PCTR; and
wherein determining the second value comprises determining a logarithm based on the second PCTR.

4. The method of claim 1, wherein determining the weight comprises:
selecting a weight;
determining a weighted average of the first quality metric with the selected weight applied and the second quality metric with the selected weight applied;
comparing the weighted average to an average of weighted averages for the content for all opportunities in which the content participated;
storing the weighted average in a first bin or a second bin based on the comparing, the first bin corresponding to weighted averages that exceed the average of the weighed averages and the second bin corresponding to weighted averages that are below the average of the weighted averages;
determining a value based on a percentage difference in conversions per unit spent by the content provider between the first bin and the second bin; and
selecting the weight based on the value.

5. The method of claim 4, wherein the weight is selected that produces the largest percentage difference, the largest percentage difference corresponding to a largest return on investment for distribution of the content.

6. The method of claim 1, wherein distributing comprises:
storing a value corresponding to the weighted average in a first bin or in a second bin, the first bin corresponding to weighted averages that exceed an average of weighted averages and the second bin corresponding to weighted averages that are below the average of weighted averages;
determining a ratio corresponding to an amount that a content provider would spend in the first bin relative to the second bin; and
determining a probability that the content should be throttled; and
wherein the content is distributed based on the ratio and the probability.

7. The method of claim 6, wherein the ratio is defined as “r” and the probability is defined as “p”;
wherein if p·(r+1)>r, then distributing comprises the content competing in a content auction for queries in the first bin with probability “1” and competing in the content auction for queries in the second bin with probability p·(r+1)−r; and
wherein if p·(r+1)≦r, then distributing comprises the content competing in a content auction for queries in the first bin with probability p·(r+1)/r and competing in the content auction for queries in the second bin with probability “0”.

8. The method of claim 1, wherein the content comprises online advertising, and the opportunity for distribution of content comprises a content auction.

9. The method of claim 1, wherein determining the first value comprises determining a logarithm of odds of the first PCTR; and
wherein determining the second value comprises determining a logarithm of odds of the second PCTR.

10. One or more non-transitory machine-readable storage media storing instructions that are executable by one or more processing devices to perform comprising:
determining a first quality metric that is indicative of a quality of an opportunity for distribution of content from a content provider as compared to other content providers, the first quality metric being based on a first predicted access rate of the content and a second predicted access rate of the content, the first predicted access rate of the content being based on features that are dependent on the content provider, the second predicted access rate of the content being based on features that are independent of the content provider;
determining a second quality metric that is based on the first predicted access rate of the content;
determining a weight to apply to the first quality metric and to the second quality metric, the weight being based on an expected return resulting from distribution of the content;
determining a weighted average of the first quality metric and the second quality metric that is based on the weight; and
distributing the content via a content auction based, at least in part, on the weighted average.

11. The one or more non-transitory machine-readable storage media of claim 10, wherein determining the first quality metric comprises:
determining a first predicted click-through rate (PCTR) for the content, the first PCTR corresponding to the first predicted access rate;
determining a first value based on the first PCTR;
determining a second PCTR, the second PCTR corresponding to the second predicted access rate;
determining a second value based on the second PCTR; and
determining the first quality metric based on a difference between the first value and the second value.

12. The one or more non-transitory machine-readable storage media of claim 10, wherein determining the first value comprises determining a logarithm based on the first PCTR; and
wherein determining the second value comprises determining a logarithm based on the second PCTR.

13. The one or more non-transitory machine-readable storage media of claim 10, wherein determining the weight comprises:
selecting a weight;
determining a weighted average of the first quality metric with the selected weight applied and the second quality metric with the selected weight applied;
comparing the weighted average to an average of weighted averages for the content for all opportunities in which the content participated;
storing the weighted average in a first bin or a second bin based on the comparing, the first bin corresponding to weighted averages that exceed the average of the weighed averages and the second bin corresponding to weighted averages that are below the average of the weighted averages;
determining a value based on a percentage difference in conversions per unit spent by the content provider between the first bin and the second bin; and
selecting the weight based on the value.

14. The one or more non-transitory machine-readable storage media of claim 4, wherein the weight is selected that produces the largest percentage difference, the largest percentage difference corresponding to a largest return on investment for distribution of the content.

15. The one or more non-transitory machine-readable storage media of claim 10, wherein distributing comprises:
storing a value corresponding to the weighted average in a first bin or in a second bin, the first bin corresponding to weighted averages that exceed an average of weighted averages and the second bin corresponding to weighted averages that are below the average of weighted averages;
determining a ratio corresponding to an amount that a content provider would spend in the first bin relative to the second bin; and
determining a probability that the content should be throttled; and
wherein the content is distributed based on the ratio and the probability.

16. The one or more non-transitory machine-readable storage media of claim 15, wherein the ratio is defined as “r” and the probability is defined as “p”;
wherein if p·(r+1)>r, then distributing comprises the content competing in a content auction for queries in the first bin with probability “1” and competing in the content auction for queries in the second bin with probability p·(r+1)−r; and
wherein if p·(r+1)≦r, then distributing comprises the content competing in a content auction for queries in the first bin with probability p·(r+1)/r and competing in the content auction for queries in the second bin with probability “0”.

17. The one or more non-transitory machine-readable storage media of claim 10, wherein the content comprises online advertising, and the opportunity for distribution of content comprises a content auction.

18. The one or more non-transitory machine-readable storage media of claim 10, wherein determining the first value comprises determining a logarithm of odds of the first PCTR; and
wherein determining the second value comprises determining a logarithm of odds of the second PCTR.

19. A system comprising:
one or more non-transitory machine-readable storage devices storing instructions that are executable; and
one or more processing devices to execute the instructions to perform operations comprising:
determining, by the one or more processing devices, a first quality metric that is indicative of a quality of an opportunity for distribution of content from a content provider as compared to other content providers, the first quality metric being based on a first predicted access rate of the content and a second predicted access rate of the content, the first predicted access rate of the content being based on features that are dependent on the content provider, the second predicted access rate of the content being based on features that are independent of the content provider;
determining, by the one or more processing devices, a second quality metric that is based on the first predicted access rate of the content;
determining, by the one or more processing devices, a weight to apply to the first quality metric and to the second quality metric, the weight being based on an expected return resulting from distribution of the content;
determining, by the one or more processing devices, a weighted average of the first quality metric and the second quality metric that is based on the weight; and
distributing, by the one or more processing devices, the content via a content auction based, at least in part, on the weighted average.

20. The system of claim 18, wherein determining the weight comprises:
selecting a weight;
determining a weighted average of the first quality metric with the selected weight applied and the second quality metric with the selected weight applied;
comparing the weighted average to an average of weighted averages for the content for all opportunities in which the content participated;
storing the weighted average in a first bin or a second bin based on the comparing, the first bin corresponding to weighted averages that exceed the average of the weighed averages and the second bin corresponding to weighted averages that are below the average of the weighted averages;
determining a value based on a percentage difference in conversions per unit spent by the content provider between the first bin and the second bin; and
selecting the weight based on the value.
